(19) United States
(12) Patent Application Publication
(10) Pub. No.: US 2026/0104283 A1
(43) Pub. Date: Apr. 16, 2026

(54) METER FOR A FLUID

(71) Applicant: PIETRO FIORENTINI S.p.A., Arcugnano (VI) (IT)

(72) Inventors: Mario VIANELLO, Rosate (MI) (IT); Claudio IMBOCCIOLI, Creazzo (VI) (IT)

(73) Assignee: PIETRO FIORENTINI S.p.A., Arcugnano (VI) (IT)

(21) Appl. No.: 19/116,392

(22) PCT Filed: Oct. 13, 2023
(86) PCT No.: PCT/IB2023/060353

§ 371 Date: Mar. 28, 2025

(30) Foreign Application Priority Data
Oct. 14, 2022 (IT) 102022000021270

(51) Int. Cl. G01F 15/14; G01F 15/06; G01F 15/063; G01F 15/18

(52) U.S. Cl. CPC G01F 15/14; G01F 15/063; G01F 15/065; G01F 15/185

(57) ABSTRACT

Meter for a fluid includes: a casing crossed by the fluid to be measured; inlet and outlet mouths for the flow of the fluid; a detection module housed in the casing that detects one or more quantities relating fluid passing through the casing; a processing section that includes:
a first containment structure external with respect to the casing;
a first electronic control and/or processing unit housed inside the first containment structure;
first optical communication means mounted on and/or housed in the first containment structure; and
a communication section which includes:
a second containment structure external with respect to the casing,
a communication module,
second optical communication means, and
a second electronic control and/or processing unit.

The first and second containment structures are removably mechanically associable with each other so that, when associated with each other, the first optical communication means are capable of communicating with the second optical communication means.

### CROSS-REFERENCE TO RELATED APPLICATIONS

The present application is a § 371 Nationals Phase of International Patent Application No. PCT/IB2023/060353, filed Oct. 13, 2023, which claims priority of Italian Patent Application No. 102022000021270, filed Oct. 14, 2022, the entire contents of all of which are incorporated by reference herein as if fully set forth.

### TECHNICAL FIELD

The present invention concerns an improved meter for a fluid, and in particular of the type suitable for measuring the flow of a fluid, for example a gas or a liquid, which enters and/or passes through the meter itself.

The invention finds advantageous use in the technical sector of the production and marketing of fluid meters and can be advantageously used both at a domestic and industrial level. Conveniently, the meter according to the invention can be used for counting gas or water consumption in a domestic or industrial system, or for counting gas or water consumption in general, for example at the outlet from a tank.

### BACKGROUND

Currently, the so-called “Smart Meters” are known-also called “remotely managed meters”—which are now widely used to measure consumption (civil and industrial) of the quantity of energy consumed in the form of gas or of the quantity of water coming from a aqueduct used by a user. In particular, these devices are gradually replacing traditional meters which limited themselves to measuring gas or water and presenting the measurement result in the format of an incremental totalizer. Appropriately, in fact, the need to comply with increasingly complex measurements, to make the consumer aware of their consumption, to provide detailed invoicing based on actual consumption, has led to the introduction of “smart meters”.

One of the peculiar and fundamental characteristics of the well-known “smart meters” is the presence of a communication module that includes means for remote data transmission, in particular for transmitting remotely-in particular to a remote central data processing system (called “SAC”)—the data representative of the quantities detected by the meter's sensors and calculated by a processing module with which the meter itself is provided.

In particular, in the known solutions, the module for processing the quantities detected by the sensors (which thus defines the metrological section of the meter) and the communication module are housed inside the same external container which is made integral with the casing to which the fluid to be measured flows inside. More in detail, the external container, in which the processing module and the communication module are housed, is already fixed in the factory to the casing in which the fluid to be measured flows so as to prevent its removal except through tampering, thus invalidating the measurement of the fluid (obtained by the meter) which is legally recognized. In particular, this is necessary to safeguard the metrological functions and the information contained in the processing module and which are used to measure consumption according to the regulations established in the sector.

Furthermore, generally the external container can be associated with a display for viewing the values relating to the detected and/or calculated quantities.

These known solutions are not completely satisfactory as they do not allow the simple communication module of the meter to be replaced easily and “in the field” (i.e. at a time subsequent to installation and possible use) and, in particular, they do not allow replace the communication module without intervening on the metrological section and/or without dismantling the entire meter from the corresponding pipe or system in which it is installed. Consider that the need to replace the communication section is currently a particularly felt need, in particular the aim of being able to adapt the same meter to use different radio technologies for remote data communication, for example in terms of frequency bands used and/or or in terms of data transmission protocols.

Furthermore, consider that both the communication module and the processing module of the metrological section must be electrically powered and, for this aim, the meter is generally provided with two separate power batteries, one for each module. Therefore, in the known solutions, when the operation of replacing the communication module power battery in the event of its exhaustion is carried out in the field (i.e. following installation and use), the electronic part of the processing module is also accessed of the metrological section and, in the case of meters installed in potentially explosive areas, this requires the use of specific construction measures which lead to an increase in the production costs of the meter, as well as making the certification procedure more complex.

US2011/313694 concerns a modular and expandable measuring device including a protected area. In particular, the measuring device comprises a two-part casing configured to be mechanically removably connected each other to, an internal module located in the protected area, an external module located outside the protected area, and an optical interface which is arranged in the internal module and/or in the external module and which is used for communication and also for detecting the opening of the protected area.

US2013/298695 concerns a measuring device which comprises a meter for determining the flow rate of a fluid flowing through a measuring tube and a plurality of modules which are mechanically connected on the meter and, in particular, these modules comprise a unit of measurement for detecting the physical, chemical or biological properties of the fluid, an evaluation unit for evaluating the data detected by the measurement unit, and a communication unit; the measuring unit, the evaluation unit, the communication unit and the meter communicate with each other electronically and/or acoustically and/or optically.

CN204759731 concerns a wireless communication system for a water meter which includes an optical transmission module which is mounted on the body of the meter so as to protrude externally from the corresponding wall of said body. The optical transmission module is intended to be connected, via a dedicated ferrule or sleeve, to an optical reception module mounted at the end of a cable.

### OBJECTS OF THE INVENTION

The aim of the invention is to propose a meter which allows the aforementioned drawbacks present in traditional solutions to be overcome, at least in part.

Another aim of the invention is to propose a meter which is constructively simple, safe and reliable.

Another aim of the invention is to propose a meter that is particularly simple to assemble.

Another aim of the invention is to propose a meter that can use different wireless communication technologies.

Another aim of the invention is to propose a meter that allows rapid and easy replacement of the communication module, even in the field (i.e. following its installation or its possible use).

Another aim of the invention is to propose a meter that allows the replacement of the communication module, without having to undergo mandatory new and further certification.

Another aim of the invention is to propose a meter that allows the replacement in the field of some of its components, in particular those that deteriorate more easily or quickly.

Another aim of the invention is to propose a meter which is particularly simple to assemble and which, at the same time, allows rapid and easy replacement—even in the field—of some of its components and/or the communication module, and this guarantees a high useful life, reliability as well as high precision and accuracy of the data measured and communicated externally.

Another aim of the invention is to propose a meter that is an improvement and/or alternative to traditional ones.

Another aim of the invention is to propose a meter that has high safety standards.

Another aim of the invention is to propose a meter that allows an accurate and precise calculation of gas volumes, also for tax aims.

Another aim of the invention is to propose a meter which has a long useful life.

Another aim of the invention is to propose a meter that can be simply, quickly manufactured and at low costs.

Another aim of the invention is to propose a meter that is highly compact and integrated.

Another aim of the invention is to propose a meter that can be easily and quickly installed, as well as replaced, at the point of delivery to a gas user, supplied by a distribution network, and which is simple and intuitive to use.

Another aim of the invention is to propose a meter that presents an alternative characterization, both in constructive and functional terms, compared to traditional ones.

### SUMMARY

All these aims, either alone or in any combination thereof, and others that will result from the following description are achieved, according to the invention, with a meter as defined below.

### BRIEF DESCRIPTION OF THE DRAWINGS

The present invention is further clarified below in some of its preferred practical embodiments reported for purely illustrative and non-limiting aims with reference to the enclosed drawings, in which

FIG. 1A shows a perspective view of a meter according to the invention,

FIG. 1B shows a front view of the meter in FIG. 1A,

FIG. 2 shows a view of the meter in FIG. 1A according to a vertical section obtained in correspondence with the processing and communication sections,

FIG. 3A shows a first perspective view of the meter in FIG. 2 in which the communication section is represented exploded compared to the remaining part of the meter,

FIG. 3B shows a second and different perspective view of the meter in FIG. 3A in which the communication section is shown in an exploded view compared to the remaining part of the meter,

FIG. 3C shows an enlarged detail of FIG. 3A,

FIG. 3D shows an enlarged detail of FIG. 2 and, in particular, shows a sectional detail and an enlarged detail of the meter in FIG. 1A at the optical communication interface,

FIG. 4A shows a first perspective view of a second embodiment of the meter according to the invention, in which the communication section is shown exploded with respect to the remaining part of the meter,

FIG. 4B shows a second and different perspective view of the meter in FIG. 4A, in which the communication section is shown exploded compared to the remaining part of the meter,

FIG. 4C shows an enlarged detail of FIG. 4A,

FIG. 4D shows a sectional view of an enlarged detail of the meter in FIG. 4A at the optical communication interface,

FIG. 5A shows a first perspective view of a third embodiment of the meter according to the invention, in which the communication section is shown exploded with respect to the remaining part of the meter,

FIG. 5B shows a second and different perspective view of the meter in FIG. 5A, in which the communication section is shown in an exploded view compared to the remaining part of the meter,

FIG. 5C shows an enlarged detail of FIG. 5 B,

FIG. 5D shows a sectional view of an enlarged detail of the meter in FIG. 5A at the optical communication interface,

FIG. 6 shows a sectional view of an enlarged detail of a variant of the meter in FIG. 5A at the optical communication interface.

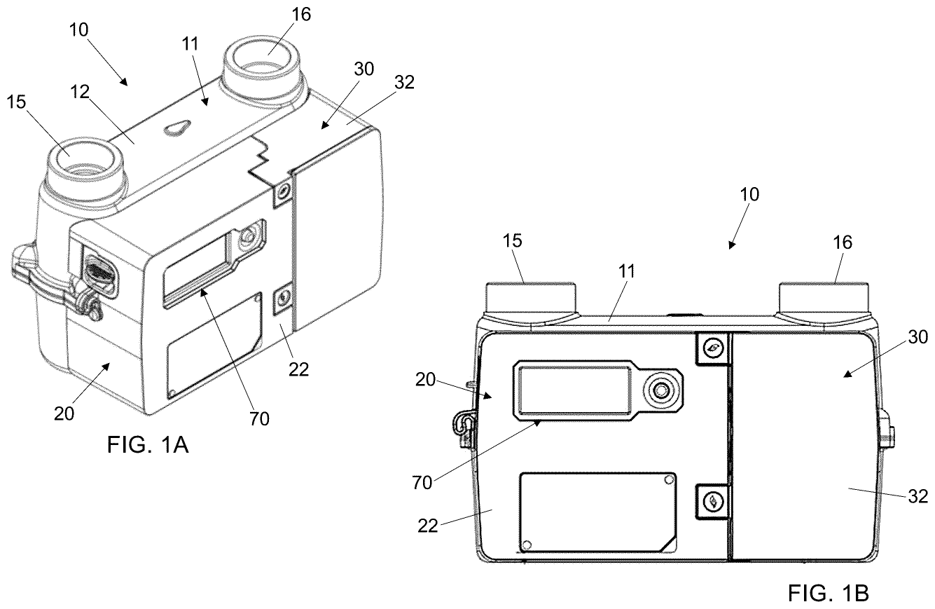

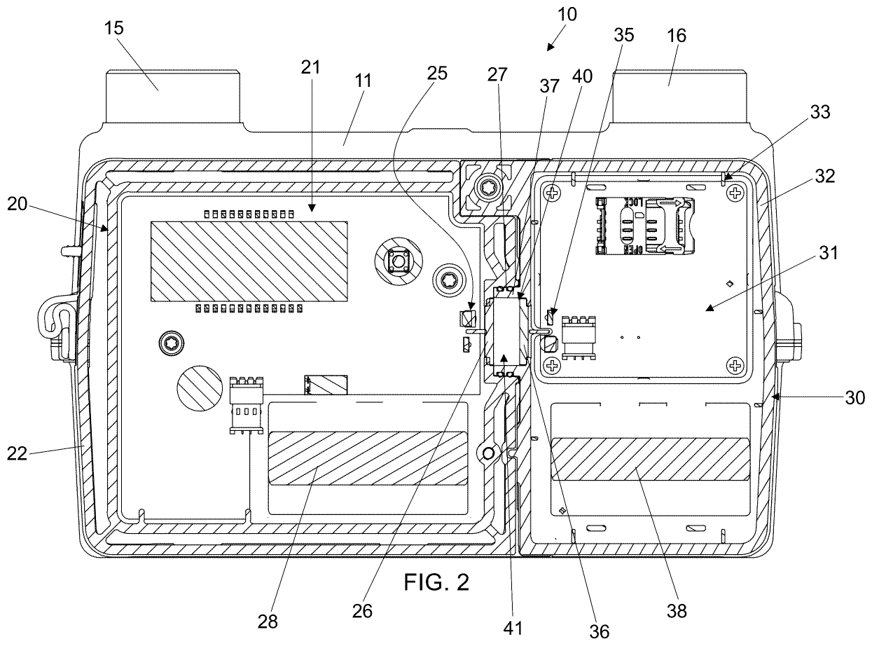

### DETAILED DESCRIPTION OF THE PREFERRED EMBODIMENTS

With reference to the cited figures, the present invention relates to a meter, which is indicated as a whole with the number 10, which is configured for the measurement of a fluid.

Conveniently, said fluid to be measured can be a gas and, in particular, it is natural gas or gas of another type produced in a decentralized way, such as biomethane or hydrogen. Conveniently, said fluid to be measured can be a liquid, for example water.

Suitably, the meter 10 can be a gas meter or a water meter. Preferably, the 10 meter is a “smart meter”.

Conveniently the meter 10 is configured to indicate at least the total volume of the gas or liquid passed through the section of which the meter itself is installed and, more in detail, is suitable for measuring at least the flow rate and/or flow of said gas or liquid.

The 10 meter includes:
a casing 11 configured to be crossed by the fluid to be measured,
an inlet mouth 15 and an outlet mouth 16 for the passage of a flow of fluid (gas or liquid), respectively entering inside the casing 11 and exiting from the casing 11.

Conveniently, the meter 10 can be configured to measure one or more quantities relating to the fluid that passes through the casing 11 of the meter itself.

Conveniently, the inlet 15 and outlet 16 are formed on the casing 11. Preferably, the inlet 15 is formed on an upper wall 12 of the casing 11. Preferably, the outlet 16 is formed on an upper wall 12 of the casing 11. Conveniently, it is to be understood that the inlet mouth 15 and the outlet mouth 16 can both be made on another same wall of the casing 11 which is not the upper wall 12. It is to be understood that the inlet mouth 15 and the outlet mouth 16 can each be made on a respective wall of the casing 11, different from the wall on which the other mouth is made.

Conveniently, the casing 11 of the meter 10 can be associated—at its inlet mouth 15—with a fluid inlet, for example defined by a section of pipe upstream of the meter 10, while it can be associated-at its mouth outlet 16—with a fluid outlet, for example defined by a section of pipe downstream of said meter. In particular, the inlet mouth 15 can be fluidly connected to the fluid inlet, to allow the fluid to enter inside the casing 11, and the outlet mouth can be fluidly connected to the outlet, to thus allow the fluid, which entered/circulated in the casing 11, to escape from the latter.

Conveniently, the casing 11 is watertight to thus prevent the fluid to be measured from leaking outwards. Preferably, the casing 11 is formed by two or more parts 11′ and 11″ which are joined together so as to guarantee the hermeticity of the entire casing. Preferably, the casing is made of metal, in particular by pressing a metal sheet or by die casting (for example of aluminum).

Inside the casing 11 of the meter 10 there is a detection module (not shown) of one or more quantities of the fluid passing through the casing 11, preferably for the detection of one or more quantities for determining the flow rate of the fluid which enters/crosses the casing 11 of the meter itself.

Preferably, the detection module includes at least one sensor to detect the flow rate of the fluid entering and/or passing through the casing 11. Preferably, said flow rate sensor is of the static type and, conveniently, can be ultrasonic or thermo-mass. Conveniently, the detection module can include a plurality of further sensors (for example pressure and/or temperature) which are configured to detect corresponding quantities of the fluid flow that enters and passes through the casing 11 and/or also quantities relating to the environment in which the meter is installed. The flow sensor and/or additional sensors are traditional in themselves and will therefore not be described further.

Advantageously, a shut-off valve (not shown) can also be housed inside the casing 11 of the meter 10. Preferably, the shut-off valve is a solenoid valve. Preferably, said shut-off valve can be an on-off type safety valve. Conveniently, the shut-off valve can be positioned in correspondence with the inlet port 15 or the outlet port 16.

The meter 10 includes a processing section 20 which is positioned outside the casing 11 and which includes:
a first containment structure 22 which is external with respect to the casing 11,
a first electronic control and/or processing unit 21 which is housed inside the first containment structure 22.

The first electronic unit 21 is electronically connected to the detection module housed inside the casing 11, to thus receive and/or process the electrical signals representative of the quantity(s) detected by the sensor(s) of the module of detection, possibly pre-processed, and/or derived from said detected quantity(s). Conveniently, the detection module which is housed inside the casing 11 and the processing section 20 provided outside the casing 11—and in particular the first electronic unit 21—are connected via wireless or via a transmission cable of electrical signals, for example a flat cable of the “FFC” or “FPC” type. Conveniently, the electric cable can pass from the inside to the outside of said casing 11 at and/or between the contact areas provided between the flanges of the two parts (half-shells) 11′ and 11″ defining said casing 11 (as provided for example in EP2810024 or in EP3002565, the contents of which are intended to be entirely incorporated herein by reference) and/or in correspondence with a passage opening, suitably sealed, defined in a wall or in correspondence with said flanges.

Preferably, the first electronic unit 21 of the processing section 20 is configured to process the signals received—and representative of the quantity(s) detected by the sensor(s) of the detection module, possibly pre-processed, and/or derived from said quantity(s) detected—to thus calculate one or more data representing quantities of the fluid that passes through the casing 11 of the meter itself.

Preferably, the processing section 20 acts as a processing section for metrological aims and, in particular, processes the signals received from the detection module to calculate one or more data useful for metrological aims. Conveniently, for this aim, the first electronic control and/or processing unit 21 is configured to carry out one or more processing of the signals received from the detection module to calculate one or more data useful for metrological aims.

Conveniently, the first electronic unit 21 includes its own (first) electronic board (for example a printed circuit PCB) provided with its own (first) microprocessor or microcontroller.

Conveniently, the first electronic unit 21 can comprise and/or be connected to at least a first memory unit. Conveniently, the first memory unit can be integrated inside the first electronic unit 21, in particular if the latter includes a microcontroller.

Preferably, the first containment structure 22 is integral with the casing 11 and, in particular, is fixed externally to at least one wall of the casing 11. Preferably, the inside of the first containment structure 22 is fluidly separated from the inside of the casing 11 into which the fluid to be measured enters and/or circulates.

Advantageously, the first containment structure 22 is integral with the casing 11 so that, once they are joined together in the factory, it is no longer possible to separate them. In particular, for this aim, means are used—for example mechanical blocks and/or seals and/or other traditional devices—which prevent the removal of the first containment structure 22 from the casing 11, except by tampering with them, thus invalidating the gas measurement (obtained using the meter 10) which is legally recognized. In particular, this is necessary to safeguard the metrological functions and the information contained in the processing section 20 and which are used to measure the volumes and/or consumption of fluid (in particular gas) according to the regulations established in the sector.

Preferably, access to the first containment structure 22 and/or to the casing 11 is prevented by one or more seals which must necessarily be tampered with in order to access the inside of said first containment structure and/or said casing. In this way, therefore, any intervention, tampering or removal of the detection module and/or of the processing section 20 can be appropriately and immediately identified. Preferably, said seals can comprise adhesive portions, padlocks, threads, or any other means that is suitable for the aim. Preferably, said seals can include means of mechanical engagement between two or more pieces, means which are configured so that, once said mechanical engagement has been defined/activated, this can be removed-and therefore the corresponding pieces can be disjoined—only by breaking—at least in part, or by visibly/evidently and permanently damaging the pieces themselves and/or said vehicles. In other words, said means can be configured to define a non-removable commitment, unless causing the corresponding breakage or damage.

Preferably, the first containment structure 22 is made of plastic. Conveniently, the first containment structure 22 can be made in a single piece or in several pieces fixed together.

Preferably, the first containment structure 22 has a substantially box-like shape.

Preferably, the first containment structure 22 is configured to be protected from external access of liquids and solid particles and, in particular, is configured so as to have an IP degree greater than or equal to IP54 and, more preferably, equal to the defined IP68 according to the corresponding regulations in force (in particular according to the IEC 60529 standard).

Preferably, the processing section 20 includes a first electric battery 28 which is housed inside the first containment structure 22 for the electrical power supply of the components housed inside the first containment structure 22. Conveniently, the first electric battery 28 can be connected directly—or via the first electronic unit 21—to the various components housed inside the first containment structure 22 in order to provide the electrical energy for their operation.

The meter 10 includes a communication section 30 which is positioned outside the enclosure 11 and also outside the first containment structure 22 of the processing section 20.

The communication section 30 includes:
a second containment structure 32 which is external with respect to the casing 11,
a second electronic control and/or processing unit 31 which is housed inside the second containment structure 32,
a communication module 33 for transmitting and/or receiving data via radio with the outside of the meter 10, said communication module 33 being electronically mounted on and/or connected with said second electronic unit 31.

Conveniently, the second electronic unit 31—which is separate, and therefore distinct/additional, compared to the first electronic unit 21—includes its own (second) electronic board (for example a printed circuit PCB) provided with its own (second) microprocessor or microcontroller.

Conveniently, the second electronic unit 31 can comprise and/or be connected to at least a second memory unit. Conveniently, the second memory unit can be integrated inside the second electronic unit 31, in particular in the case in which the latter includes a microcontroller.

Conveniently, the communication module 33 includes at least one radio transmitter and/or radio transceiver which can be mounted on the electronic board of the second electronic unit 31 and/or can be connected to said board.

Conveniently, the communication module 33 is configured to transmit and/or transceive data with a portable device (not shown) that is external to the meter 10, for example a smartphone or tablet, and/or with a remote processing unit external (for example an external and remote central unit that is configured to receive information from a plurality of meters 10).

Preferably, the first containment structure 22 is galvanically isolated from the second containment structure 32.

The first containment structure 22 of the processing section 20 and/or the second containment structure 32 of the communication section 30 are configured to be mechanically associated with each other in a removable manner.

Preferably, in a possible embodiment, the second containment structure 32 of the communication section 30 can be mechanically associated only with the first containment structure 22 of the processing section 20, therefore not being mechanically connectable to the casing 11 and at most being only in contact with said casing 11.

Conveniently, in a possible embodiment, the second containment structure 32 of the communication section 30 can be mechanically associated both with the first containment structure 22 of the processing section 20 and with the casing 11.

Preferably, the second containment structure 32 is made of plastic. Conveniently, the second containment structure 32 can be made in a single piece or in several pieces fixed together.

Preferably, the second containment structure 32 has a substantially box-like shape.

Preferably, the second containment structure 32 is configured to be protected from external access of liquids and solid particles and, in particular, is configured so as to have an IP degree greater than or equal to IP54 and, more preferably, equal to the defined IP68 according to the corresponding regulations in force (in particular according to the IEC 60529 standard).

Preferably, the second containment structure 32 is galvanically isolated with respect to the first containment structure 22 and with respect to the casing 11.

Preferably, the communication section 30 includes a second electric battery 38 which is housed inside the second containment structure 32 for the electrical power supply of the components housed inside the second containment structure 32. Conveniently, the second electric battery 38 it can be connected directly—or via the second electronic unit 31—to the various components housed inside the second containment structure 32 in order to provide the electrical energy for their operation.

Advantageously, therefore, the processing section 20 and the communication section 30 are electrically autonomous and separate, also from the point of view of the electrical power supply of the components housed inside the respective containment structures 22 and 32.

Advantageously, as mentioned, the two sections 20 and 30—respectively for processing and communications—have two distinct containment structures 22 and 32 which can be mechanically associated with each other in a removable manner.

Advantageously, moreover, the two containment structures 22 and 32—respectively of the processing section 20 and communication section 30—can both be galvanically isolated and, considering that the meter is or can be installed in an explosion-hazardous area (for example classified as “Class 1—Division 1” according to the “NEC classification”), the galvanic isolation between the processing section 20 and the communication section 30 allows the corresponding energy and electrical contributions to be kept separate, thus simplifying the meter certification process and also its construction, and therefore reducing the related production costs.

Conveniently, therefore, the two containment structures 22 and 32—respectively of the processing section 20 and communication section 30—are galvanically isolated and are mechanically/structurally separated and independent each other from, although they can be mechanically associated with each other in a removable way, as discussed in more detail below. Advantageously, this allows the communication section 30 to be replaced freely and easily without having to intervene on the electrical part of the processing section 20.

The processing section 20 also includes first optical communication means 25 which are mounted on and/or housed in said first containment structure 22 and which are electronically mounted on and/or connected with said first electronic unit. Preferably, the first communication means 25 comprise an infrared transmitter or transceiver which can be mounted on the same electronic board on which the microprocessor/microcontroller of the first electronic unit 21 of the processing section 20 is mounted.

The communication section 30 also includes second optical communication means 35 which are mounted on and/or housed in said second containment structure 32 and are electronically mounted on and/or connected with said first electronic unit 31. Preferably, the second communication means communication 35 comprise an infrared receiver or transceiver which can be mounted on the same electronic board on which the microprocessor/microcontroller of the second electronic unit 31 of the communication section 30 is mounted.

Conveniently, the first optical communication means 25 of the processing section 20 are configured to communicate—preferably in transmission and/or transmission—with the second optical communication means 35 of the communication section 30, to thus allow the passage of optical signals, and therefore of data, between the processing section 20 and the communication section 30. In essence, advantageously, the first optical communication means 25 and the second optical communication means 35 define an optical communication interface 40 between the processing section 20 and the communication section 30.

Preferably, the first optical communication means 25 are of the infrared type and, correspondingly, the second communication means 35 are of the infrared type. Conveniently, therefore, the optical communication interface 40 is of the infrared type.

In one possible embodiment, the first optical communication means 25 comprises an infrared transmitter, for example an LED configured to emit infrared radiation, while the second communication means 35 comprises an infrared receiver, thus allowing the communication of signals to infrared only from the first means 25 of the processing section 20 towards the second means 35 of the communication section 40.

In another possible embodiment, the first optical communication means 25 comprises an infrared transceiver (e.g. with a LED configured to emit infrared radiation and a receiver for capturing the infrared radiation), and the second communication means 35 comprises an infrared transceiver (e.g. with a LED configured to emit infrared radiation and a receiver to capture infrared radiation), thus allowing bidirectional communication of infrared signals between the first means 25 of the processing section 20 and the second means 35 of the communication section 30.

Conveniently, the first electronic unit 21 can be configured to transform the data—processed by the same first electronic unit 21 and preferably corresponding to and/or deriving from the processing of the values of the quantities of the fluid to be measured obtained by the detection module—into signals that can be transmitted via the first optical communication means 25 to the second optical communication means 35, and can thus pass from the processing section 20 to the communication section 30.

Preferably, through the optical communication interface 40, the processing section 20 sends to the communication section 30 in the form of optical signals, preferably infrared, the data useful for metrological aims that have been calculated within the processing section 20.

Conveniently, the second electronic unit 31 can be configured to transform the optical signals received from the first optical communication means 25 into data that can be transmitted outside the meter 10 via the communication module 33.

Conveniently, the second electronic unit 31 can be configured to transform the data—received from the outside via the communication module 33—into signals that can be transmitted via the second optical communication means 35 to the first optical communication means 25.

Preferably, the infrared signals transmitted from the first means 25 of the processing section 20 to the second means 35 of the communication section 30 are representative of and/or are derived from the data resulting from the processing carried out by the first electronic unit 21 on the basis of what is measured by the detection module relating to the quantities of the fluid that passes through the casing 11 of the meter itself.

Preferably, the infrared signals transmitted from the second means 35 of the communication section 30 to the first means 25 of the processing section 20 can include control and/or setting signals received from outside the meter 10.

The optical communication interface 40 is particularly advantageous in terms of costs, in particular compared to a radio communication interface with the Bluetooth standard which is more expensive in terms of hardware components.

Conveniently, the communication between the processing section 20 and the communication section 30 can take place exclusively through the optical communication interface 40, or—in addition to said optical communication interface—a radio communication interface can be provided between said two sections and, for this aim, corresponding radio transmission and/or reception units can be provided in the latter.

The first containment structure 22 of the processing section 20 and the second containment structure 32 of the communication section 30 are configured so that, when said structures are mechanically associated with each other, the first optical communication means 25 are capable of communicating with the second optical communication means 35, to thus define an optical communication interface 40 between the processing section 20 and the communication section 30. In particular, the optical signals-preferably infrared-emitted by the first means 25 can be received by the seconds means 35, or vice versa. Conveniently, for this aim, when the two containment structures 22 and 32 are mechanically associated with each other, the first optical communication means 25 face the second optical communication means 35.

Preferably, the processing section 20 includes at least a first window 26 configured to be crossed by optical signals, preferably infrared, emitted by the first optical communication means 25. Preferably, the first window 26 is provided in correspondence with the receiving portion 27 (or in the case of the insertion portion) of said first containment structure 22. Conveniently, said first window 26 includes a portion made of glass or a transparent material (for example transparent polycarbonate), or in any case in a material suitable to allow the passage of signals opticians. Conveniently, the first optical communication means 25 can be mounted inside the first containment structure 22 in correspondence with and/or facing said first window 26. Advantageously, the first window 26 can be welded—preferably ultrasonically—to the first containment structure 22.

Preferably, the communication section 30 includes at least a second window 36 configured to be passed through by optical signals, preferably infrared, emitted by the second optical communication means 35. Preferably, the second window 36 is provided in correspondence with the insertion portion 37 (or in the case of the receiving portion) of the second containment structure 32. Conveniently, said second window 36 includes a corresponding portion made of glass or other transparent material (for example transparent polycarbonate), or in any case in a material suitable to allow the passage of signals optical, preferably infrared, emitted by the second optical communication means 35. Conveniently, the second optical communication means 35 can be mounted inside the second containment structure 32 in correspondence with and/or facing said second window 36. Advantageously, the second window 36 can be welded—preferably ultrasonically—to the second containment structure 32.

Preferably, when the two containment structures 22 and 32 are mechanically associated with each other, the first window 26 and the second window 36 face each other to, at least partially.

Conveniently, the first containment structure 22 includes a receiving portion 27 (which acts as a “female portion” or “socket”) into which an insertion portion 37 is inserted (which acts as a “male portion” or “plug”) of the second containment structure 32, or vice versa, to thus define an optical communication channel 41 which—preferably—is protected from external access by liquids and solid particles. It is understood that, in another possible embodiment, the receiving portion 27 could be obtained on the second containment structure 32 while the insertion portion 37 could be obtained on the first containment structure 22.

Suitably, the optical communication interface 40—comprising the first optical communication means 25 of the processing section 20 and the second optical communication means 35 of the communication section 30—is defined in correspondence with the optical communication channel 41 which is defined/obtained by engaging the insertion portion 37 of the second containment structure 32 (or of the first containment structure 22) into the receiving portion 27 of the first containment structure 22 (or of the second containment structure 32). In essence, the optical communication interface 40 is positioned in the direct mechanical coupling (male-female type) between the protruding portion 37 of one section and the receiving portion 27 of the other section. Advantageously, this allows the mechanical connection between the processing section 20 and the communication section 30 and, at the same time, allows light from outside to be prevented from entering the optical communication channel 41.

Preferably, the receiving portion 27 is obtained on the first containment structure 22, while the insertion portion 37 is obtained on the second containment structure 32, or vice versa.

Preferably, the first window 26 is mounted in correspondence with said receiving portion 27, while the second window 36 is mounted in correspondence with said insertion portion 37. Preferably, the first window 26 is mounted on the bottom of the receiving portion 27, while the second window 36 is mounted on the bottom of the insertion portion 37. Preferably, when the insertion portion 37 is engaged in the receiving portion 27, the first window 26 and the second window 36 are—at least partially or, preferably, completely—facing each other to.

Conveniently, the insertion portion 37 includes a tubular section that protrudes with respect to the surrounding area of the corresponding containment structure 32 (or 22), while the receiving portion 27 includes a depressed area with respect to the surrounding area of the corresponding containment structure 22 (or 32).

Preferably, the insertion portion 37 is inserted directly into the receiving portion 27, i.e. the mechanical coupling is with direct coupling, without intermediate connection components (such as sleeves or ring nuts) to be moved/operated.

Conveniently, the insertion portion 37 can be configured to engage by form fit within the receiving portion 27. Conveniently, the insertion portion 37 can be configured to engage by friction, in particular for “press-fit ”or“ interference-fit ”, within the receiving portion 27.

Preferably, at least one gasket 50 is provided in correspondence with the insertion portion 37 and/or the receiving portion 27 which is intended to be compressed when the insertion portion 37 is engaged inside the receiving portion 27.

Preferably, said at least one gasket 50 is annular in shape and is mounted on the external walls of the protruding tubular section that defines the insertion portion 37, to be thus compressed radially by the internal walls of the receiving portion 27. Advantageously, this allows the process to be simplified of assembling the two sections 20 and 30 with each other, while at the same time guaranteeing the reliability over time of the protection from external access of liquids and solid particles in correspondence with the optical communication channel 41. Furthermore, advantageously, the seal obtained by means of said at least one gasket 50 allows to increase the useful life of the meter 10, in particular when it is installed in the field, and also allows to have a greater guarantee of having no noise or disturbances within the optical communication channel 41.

Conveniently, in a possible embodiment, said at least one gasket 50 can be mounted on the insertion portion 37 and/or the receiving portion 27 so as to be compressed axially/planarly, or both radially and axially/planarly.

Preferably, on the external walls of the protruding tubular section that defines the insertion portion 37, at least one seat can be provided, with circumferential development, for said at least one gasket 50.

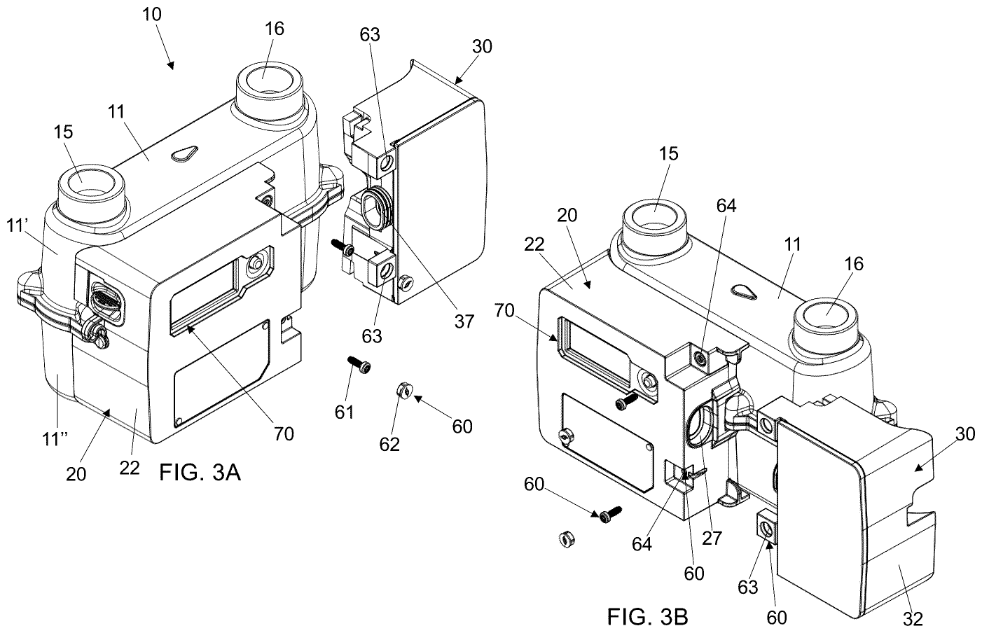

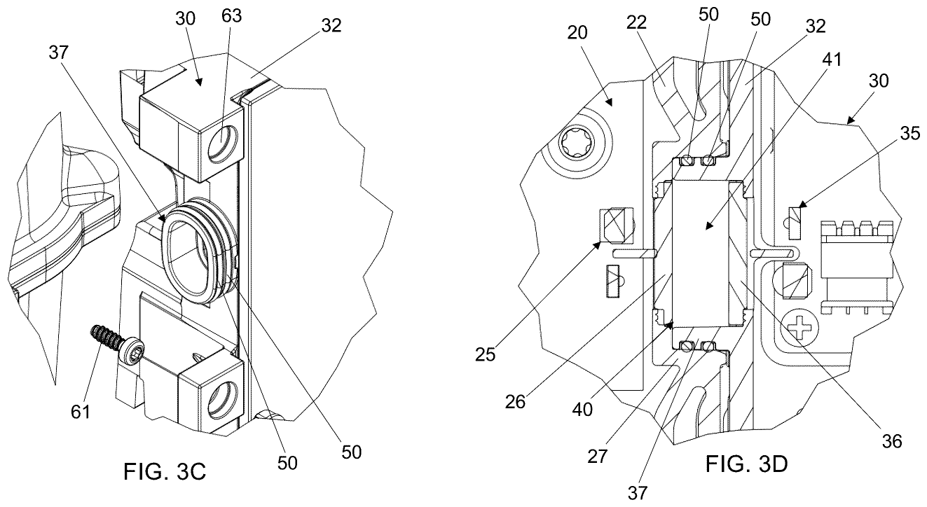

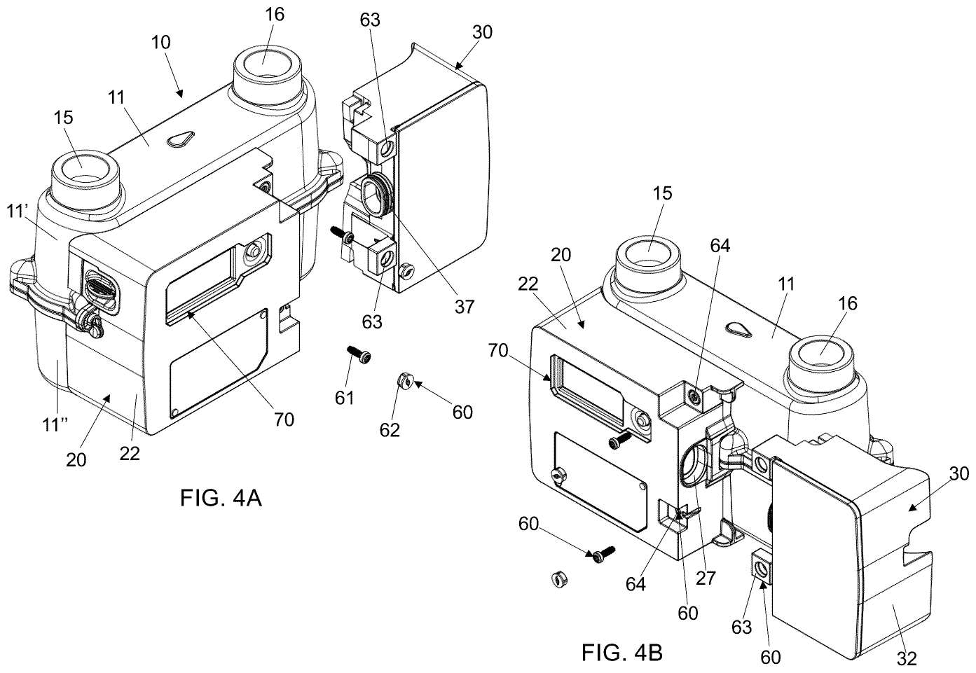

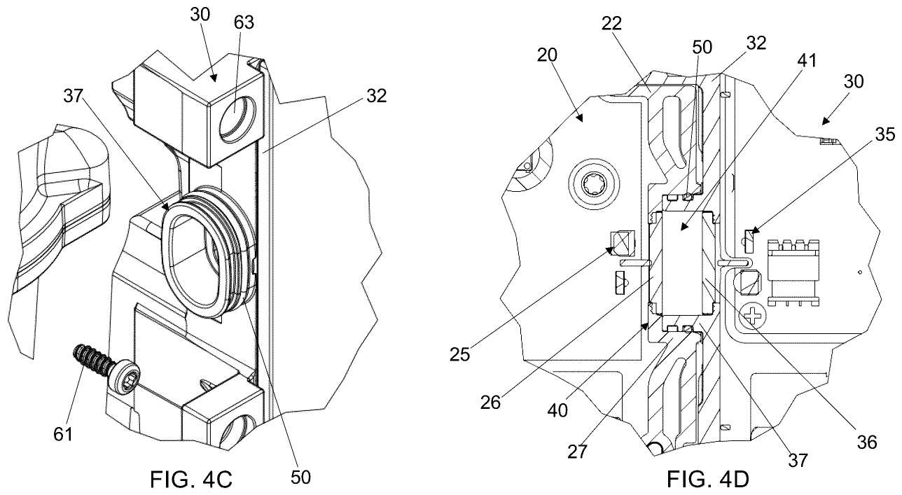

Conveniently, in a possible embodiment, only one gasket can be mounted on the protruding tubular section of the insertion portion 37 (see FIG. 4D) or, preferably, two gaskets can be mounted (see FIG. 3D).

Preferably, said at least one gasket 50 is of the “O-ring” type, thus being easily available on the market and allowing an advantageous cost saving.

Conveniently, the engagement of the insertion portion 37 of the second structure 32 of the communication section 30 within the receiving portion 27 of the first structure 22 of the processing section 20, and also the presence of said at least one seal 50 which is activated/compressed to following and/or during the aforementioned coupling, thus define a protection from external access of dust and liquids, preferably of IP68 degree, in correspondence with the optical communication channel 41. Advantageously, the fact that the windows 26 and 36—facing each other to and provided respectively in the receiving portion 27 and in the insertion portion 37—are welded, preferably ultrasound, onto the respective containment structure 20 and 30, allowing further safety in the event of deterioration or failure of the gasket 50.

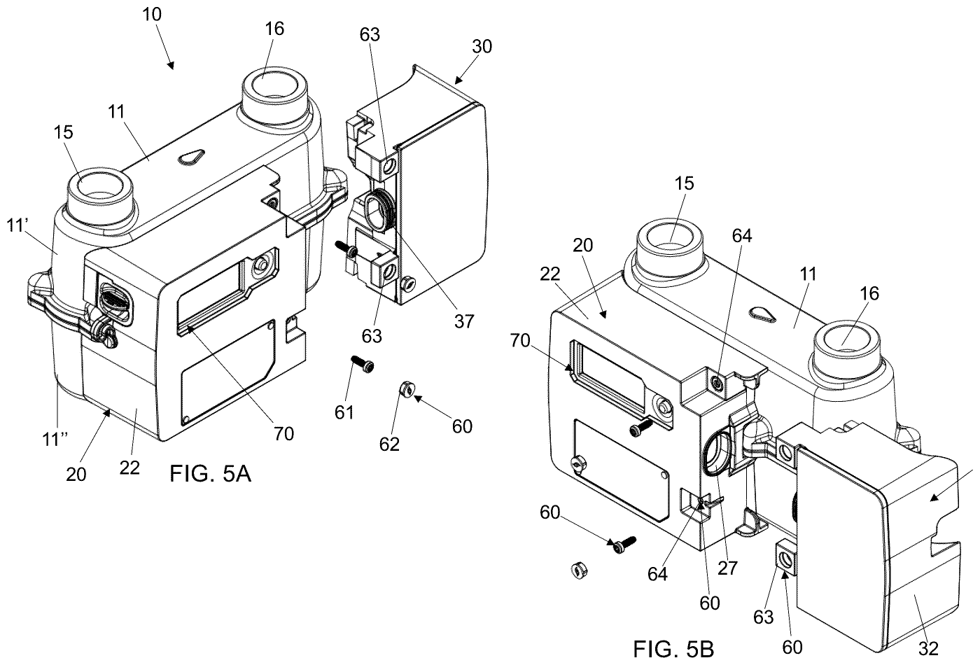

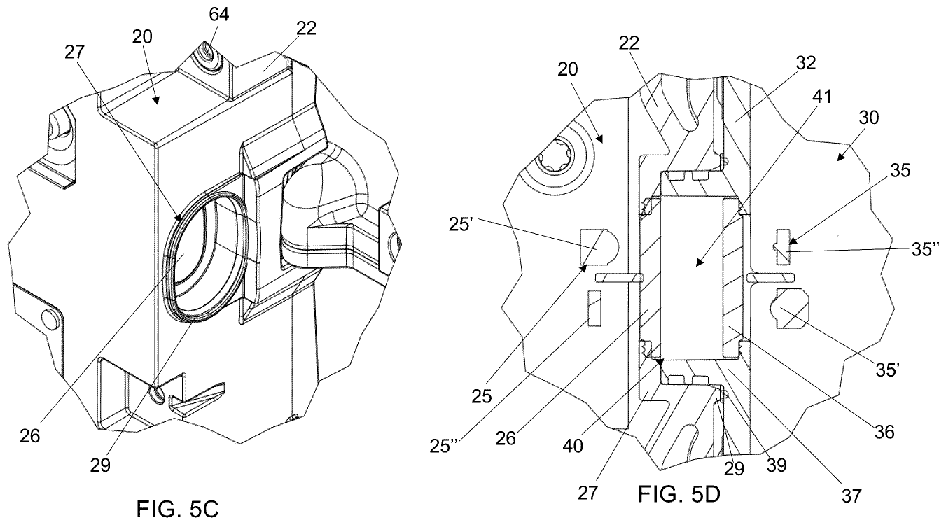

Preferably, when the insertion portion 37 is engaged in the receiving portion 27, the first window 26 and the second window 36 are spaced apart each other from. In particular, inside the optical communication channel 41, the two windows 26 and 36 are spaced apart each other from. Advantageously, this allows defining an appropriately elongated optical communication channel 41 and having a protruding tubular section, which defines the insertion portion 37, of suitable length to allow the assembly of one or more gaskets 50. In a possible embodiment (see FIGS. 5C and 5D), the protection from external access of liquids and solid particles in correspondence with the communication channel 41 can also be obtained without the use of a gasket 50 and, in this case, a engagement by friction, in particular for “press-fit” or “interference-fit”, between and/or at the insertion portion 37 and the receiving portion 27. Advantageously, a raised edge 29 can be provided around the receiving portion 27 which is configured to come into contact with the containment structure in which the insertion portion 37 is obtained, preferably to engage by form coupling within a groove 39 obtained around the insertion portion 37.

Conveniently, the insertion portion 37 is configured so as to abut with the outermost edge of its tubular portion protruding from the bottom of the receiving portion 27.

Advantageously, when the insertion portion 37 is completely engaged in the receiving portion 27—and preferably when the outermost edge of the protruding tubular section of the insertion portion 37 abuts on the bottom of the receiving portion 27—the corresponding facade walls of the respective insertion structures containment 22 and 32 are in mutual contact or in any case particularly close together.

Conveniently, the walls of the containment structures 22 and 32 which are intended to come into contact, or in any case to be brought closer together, can have a complementary shape and profile.

Conveniently, the first containment structure 22 and the second containment structure 32 can include fixing means 60 to connect said structures each other to. Conveniently, the fixing means 60 allow the two containment structures 22 and 32, respectively of the processing section 20 and of the communication section 30, to be fixed and kept stably joined together over time.

Conveniently, the fixing means 60 are configured to be activated when the insertion portion 37 of a containment structure is engaged-preferably entirely inside the receiving portion 27 of the other containment structure.

Preferably, the fastening means 60 comprise at least one mechanical fastening member 61 (for example a screw, a bolt or a similar element, preferably with a covering cap 62 of the respective head) which is configured to pass through at least a corresponding hole 63 and 64 obtained on each of the two containment structures 22 and 32, to thus join said two structures together. Conveniently, the fixing means 60 can include at least a through hole 63 and a threaded blind hole 64 obtained respectively on the second structure 32 and on the first structure 22, or vice versa, and in which said mechanical fixing member 61 passes through the through hole in sequence 63 and then the blind threaded one 64, to then engage in the latter.

Conveniently, the fixing means 60 can include removable mechanical engagement means for hooking (for example with clips), for press-fit, for interlocking and/or snap-fitting (also called “snap-fit”), as well as for magnetic engagement means.

Preferably, as mentioned, the two containment structures 22 and 32—respectively of the processing section 20 and communication section 30—are configured to be protected from external access of liquids and solid particles preferably with IP68 protection degree, and this is considering them separately/individually, and also when considering the assembly defined by their mechanical union.

Furthermore, preferably, the two containment structures 22 and 32—of the processing section 20 and communication section 30 respectively—are configured to be protected from external access of liquids and solid particles, preferably with IP68 protection degree, at the optical communication interface 40.

Furthermore, preferably, the two containment structures 22 and 32—of the processing section 20 and communication section 30 respectively-are configured to be protected from external access of liquids and solid particles, preferably with IP68 protection degree, at the insertion of the insertion portion 37 within the receiving portion 27, thus defining an optical communication channel 41 which is protected from external access of liquids and solid particles, preferably with IP68 protection degree.

Preferably, in a possible embodiment, the first optical communication means 25 of the processing section 20 comprise a first transmitter 25′ and a first receiver 25″, while the second optical communication means 35 of the communication section 30 comprise a second 35′ transmitter and a second 35″ receiver. Conveniently, the first transmitter 25′ faces the second receiver 35″, while the second transmitter 35′ faces the first receiver 25″. Advantageously, this allows bidirectional communication between the two sections 20 and 30.

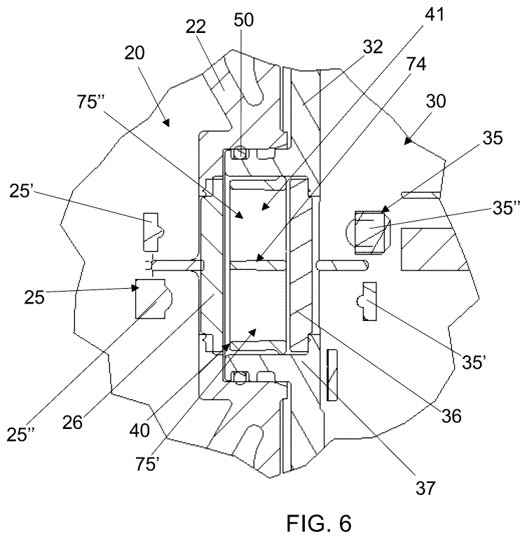

Preferably, in a possible embodiment illustrated for example in FIG. 6, a separation element 74 can be provided at the optical communication interface 40 which is configured and mounted so as to divide the channel into two sub-channels, and in particular a first sub-channel 75′ for the first transmitter 25′ of the processing section 20 which faces the second receiver 35″ of the communication section 30 and a second sub-channel 75″ for the second transmitter 35′ of the communication section 30 which faces the first receiver 25″ of the processing section 20. Advantageously this allows the avoidance of echo or reverberation phenomena of optical signals. Preferably, the two sub-channels are parallel each other to and side by side. Preferably, the separation element 74 comprises a wall that extends throughout the optical communication channel 41. Preferably, the separation element 74 is made of a material or has an opaque and/or dark coating (e.g. black), or in any case such as not to let optical signals pass; advantageously, this allows to avoid reflections of the marks inside the channel and the sub-channels. Preferably, the walls of the two sub-channels can be suitably provided with opaque and/or dark coatings (for example in black), or in any case such as not to let the optical signals pass.

Advantageously, by using an optical communication interface 40 between the two sections 20 and 30, it is possible to obtain in a simple and inexpensive way protection from the external access of liquids and solid particles within the respective containment structures 22 and 32, and in particular it is possible to have an IP68 protection degree both for the structures considered individually and in correspondence with the optical communication channel 41 in which the optical communication interface 40 is provided; in fact, it is sufficient to intervene at the mechanical design level of the two structures 22 and 32, and furthermore-unlike solutions in which communication between the two sections takes place via cable the use of special high-cost connectors is not required.

Preferably, the internal walls of the protruding portion 37 and/or of the receiving portion 27 are made of material or have a coating that is opaque and/or dark (for example black), or in any case such that it does not allow optical signals to pass. Advantageously, this allows the optical communication channel 41 to be protected from external radiation which could disturb or compromise the communication between the first optical communication means 25 and the second optical communication means 35.

Advantageously, the processing section 20 and/or the communication section 30 also includes a user interface 70—for example a pushbutton panel associated with a visualization display or a touch-screen display—configured to allow the user to interact respectively with the first electronic unit 21 of said processing section 20 and with the second electronic unit 31 of said communication section 30. Conveniently, the data received and/or processed by said first electronic unit 21 are shown on the display.

Advantageously, the first electronic unit 21 of the processing section 20 can be configured to operate as a “master”, while the second electronic unit 31 of the communication section 30 can be configured to operate as a “slave”.

Conveniently, a further electronic unit can be provided inside the casing 11 which is electronically connected with the first electronic unit 21 of the processing section 20 and also with the sensors of the detection module.

From what has been said it appears that the meter 10 according to the invention is more advantageous compared to traditional solutions as it allows the replacement of the communication section, thus adapting the communication technology on the basis of the various requests and installation needs and/or because the power supply battery of the communication section is discharged, quickly and easily, in the field and in such a way that it is legally/regulatory accepted from a metrological point of view (in particular in accordance with the provisions of the R137-1-2 regulation of the International Organization Legal Metrology), thus reducing the time and costs deriving from replacing the entire meter.

In particular, unlike US2011/313694 and US2013/298695, in the solution according to the present invention the optical communication interface—comprising the first communication means and with the second communication means—is positioned in correspondence with the mechanical coupling of male-female type (i.e. in which the insertion portion fits into the receiving portion) between the processing section and the communication section. Advantageously, on the one hand this allows for rapid assembly and replacement of the communication section, and on the other it allows defining, at the optical interface, an optical communication channel which is adequately and appropriately protected from external optical interference (such as example light pollution from outside) which could disturb or interfere in the communication between the first and second means of optical communication. Furthermore, in the solution according to the invention it is the containment structure of the communication section which includes a receiving portion, while in the solution according to CN204759731 an intermediate connection element is provided as a ring nut or sleeve between two protruding portions, of which moreover a protruding portion it is made on the end of a cable.

The present invention has been illustrated and described in one of its preferred embodiments, but it is understood that executive variations may be made to it in practice, without however departing from the scope of protection of the present patent for industrial invention.

1. Meter a fluid, the meter comprising:
a casing configured to be crossed by the fluid to be measured,
an inlet mouth and an outlet mouth for the passage of a flow of said fluid, respectively entering inside the casing and exiting the casing,
a detection module which is housed in said casing and which is configured to detect one or more quantities relating to said fluid passing through said casing,
a processing section which includes:
a first containment structure which is external with respect to the casing,
a first electronic control and/or processing unit which is housed inside the first containment structure and which is electronically connected with said detection module, to thus receive and/or process signals representative of and/or or derived from the quantities detected by said detection module,
first optical communication means which are mounted on and/or housed in said first containment structure and which are electronically mounted on and/or connected with said first electronic unit,
a communication section which includes:
a second containment structure which is external with respect to the casing,
a communication module for transmitting and/or receiving data via radio with the outside of the meter,
second optical communication means which are mounted on and/or housed in said second containment structure,
a second electronic control and/or processing unit which is housed in said second containment structure, said communication module and said second optical communication means being electronically mounted on and/or connected with said second electronic unit,
wherein:
said first containment structure and said second containment structure are configured to be mechanically associated with each other in a removable manner and so that, when said structures are mechanically associated with each other, the first optical communication means are capable of communicating with the second optical communication means, to thus define an optical communication interface between the processing section and the communication section
said first containment structure includes a receiving portion and said second containment structure includes an insertion portion, or vice versa,
said insertion portion is configured to engage within the receiving portion to thus define an optical communication channel which is protected from external access of liquids and solid particles,
said first optical communication means are mounted in correspondence with said receiving portion and in that said second optical communication means are mounted in correspondence with said insertion portion, or vice versa.

2. The meter according to claim 1, wherein the first containment structure is fixed externally to a wall of the casing, by means that prevent the removal of the first containment structure from the casing unless tampered with.

3. The meter according to claim 1, wherein the second containment structure of the communication section is mechanically associated only with the first containment structure of the processing section.

4. The meter according to claim 1, wherein the first containment structure is galvanically isolated and in that the second containment structure is galvanically isolated.

5. The meter according to claim 1, wherein:
the first containment structure is configured to be protected from external access of liquids and solid particles, with an IP protection degree greater than or equal to IP54,
the second containment structure is configured to be protected from external access of liquids and solid particles, with an IP protection degree greater than or equal to IP54.

6. The meter according to claim 1, further comprising:
a first electric battery which is housed in the first containment structure for the electrical power supply of the components housed inside the first containment structure, and
a second electric battery which is housed in the second containment structure for the electrical power supply of the components housed inside the second containment structure.

7. The meter according to claim 1, wherein:
the insertion portion includes a tubular section that protrudes with respect to the surrounding area of the corresponding containment structure, and
the receiving portion includes an area which is depressed compared to the surrounding area of the corresponding containment structure.

8. The meter according to claim 1, wherein the insertion portion is configured to engage within the receiving portion by at least one of the following: form coupling, press-fit friction engagement or interference-fit friction engagement.

9. (canceled)

10. The meter according to claim 1, wherein said first optical communication means are infrared and that said second optical communication means are infrared.

11. The meter according to claim 1, wherein:
said first electronic control and/or processing unit comprises a first electronic card,
said first optical communication means comprise an infrared transmitter or transceiver which is mounted on said first electronic board,
said second electronic control and/or processing unit includes a second electronic board,
said second optical communication means comprise an infrared transmitter or transceiver which is mounted on said second electronic board.

12. The meter according to claim 1, wherein:
the first optical communication means of the processing section comprise a first transmitter and a first receiver,
the second optical communication means of the communication section comprise a second transmitter and a second receiver,
the first transmitter faces the second receiver
the second transmitter faces the first receiver.

13. The meter according to claim 1, wherein:
said processing section includes a first window which is mounted on said receiving portion, or on said insertion portion, of said first containment structure and which faces said first means of optical communication,
said communication section includes a second window which is mounted on said insertion portion, or on said receiving portion, of said second containment structure and which faces said second means of optical communication.

14. The meter according to claim 1, wherein:
said processing section includes a first window which is configured to be crossed by the optical signals emitted by the first optical communication means, said first window being provided in correspondence with said receiving portion, or of said insertion portion, of said first containment structure,
said communication section includes a second window which is configured to be crossed by the optical signals emitted by the second optical communication means, said second window being provided in correspondence with said insertion portion, or of said receiving portion, of said second containment structure.

15. The meter according to claims 13, wherein:
said first window is welded, to the first containment structure, and
said second window is welded, to the second containment structure, and
wherein that said first window and said second window are spaced apart inside the optical communication channel.

16. (canceled)

17. The meter according to claim 1, wherein in correspondence with the insertion portion and/or the receiving portion, at least one gasket is provided which is intended to be compressed, when the insertion portion is inserted inside the receiving portion, to thus improve the protection from external access of liquids and solid particles in correspondence with the optical communication channel.

18. The meter according to claim 1, wherein said insertion portion comprises a protruding tubular section and at least one ring-shaped gasket mounted on the external wall of said protruding tubular section.

19. The meter according to one or more of the previous claim 1, wherein the first containment structure and the second containment structure also include fixing means to connect said structures together, said fixing means being configured to be activated when the insertion portion of a containment structure is engaged, within the receiving portion of the other containment structure.

20. The meter according to claim 1, wherein in correspondence with the optical communication interface a separation element, that is made of opaque and/or dark material or with an opaque and/or dark coating, is provided which is configured and mounted so as to divide the optical communication channel in a:
first sub-channel for a first transmitter of the processing section which faces a second receiver of the communication section,
a second sub-channel for a second transmitter of the communication section which faces a first receiver of the processing section.

21. The meter according to claim 20, wherein said separation element comprises a wall made of opaque and/or dark material or with an opaque and/or dark coating.

22. The meter according to claim 1, wherein the internal walls of the protruding portion and/or of the receiving portion are made of an opaque and/or dark material or comprise an opaque and/or dark coating.
